(19) United States
(12) Patent Application Publication
(10) Pub. No.: US 2006/0158548 A1
(43) Pub. Date: Jul. 20, 2006

(54) Method and Apparatus for Sensor or Transducer Nodes on a Common Signal Conductor

(75) Inventor: Ray Marc Broemmelsiek, San Diego, CA (US)

Correspondence Address: RAY BROEMMELSIEK, 7996 VILLAS, SAN DIEGO, CA, 92127, US

(73) Assignee: Mr. Ray Marc Broemmelsiek, San Diego, CA (US)

(21) Appl. No.: 10/905,743

(22) Filed: Jan. 19, 2005

(51) Int. Cl. H04N 9/73; H04N 5/225

(52) U.S. Cl. 348/373; 348/144

(57) ABSTRACT

A sensor node capable of sampling a physical measurement of its environment and capable of sharing a common signal conductor with other sensor nodes is provided. Additionally, a transducer node capable of converting an electrical signal into a human perceptible output and capable of sharing a common signal conductor with other transducer nodes is also provided. For both sensors and transducers, the invention provides for uniquely addressable access of each node, for dynamic unique address assignment of each node, and nodes that are field replaceable. When the sensor nodes are video cameras, the present invention provides for common frame synchronization, support for pan-tilt-zoom video cameras, and support for video display. The invention also provides for common frame synchronization to video nodes, which enables video decoding of the analog video signals using a single video decoder without loss of data. The invention also provides for insertion of a sensor node's unique address signal onto its output analog signal. Additionally, the invention provides for a common set of conductors supporting power, control, and sensor or transducer signal for all nodes connected to said set of conductors. Therefore, together with unique node addresses related to a position on the common set of conductors and by construction, the common signal conductor additionally provides relative physical relationship between individual sensors and transducers connected therewith.

### FIELD OF INVENTION

The present invention relates to the deployment of multiple sensors and transducers such as motion video cameras and displays, microphones and speakers, motion sensors, thermal sensors and the like particularly for use in surveillance systems and interactive environments.

### BACKGROUND OF INVENTION

In the field of video surveillance, most systems today that provide complete video coverage are prohibitively expensive because they require a large number of video cameras. For example, each individual video camera requires a video cable and a power cable. These cables must be individually run back to the video equipment for display, recording, and distribution. Pan-tilt-zoom cameras generally require an additional data feed for redirecting it. Wiring and installation cost typically is proportionally greater than the cost of the cameras. This is more pronounced for systems using less expensive sensors and transducers.

One method that is used to reduce the cost of wiring uses existing installed wiring. For example, many buildings and other commercial facilities are installed with cabling for phone and computer networks. In these cases, the transducers or sensors, cameras being exemplary for their higher cost per unit, are designed and manufactured to adapt to this available wiring. For example IP (internet protocol) cameras use a standard camera with an interface that supports digital transport of the video data on a TCP/IP network. One IP camera requires exclusive use of the attached network cable. Today, these IP cameras are several times more expensive than an equivalent analog camera and their video quality is degraded from digital video compression artifacts. Another approach makes better use of the network cable, by using analog cameras with a networked video server. These video servers receive video from several cameras and convert their signals for transport onto the network. Video servers are merely another IP camera configuration suffering similar shortcomings.

Another method further reduces wiring costs for IP cameras by placing power onto Ethernet so that an IP camera can also receive power from the network connection. This method also has the limitation of only supporting one sensor per network cable. Yet another method that combines cable functions called “up-the-coax” uses conventional video coaxial cable to deliver video from a pan-tilt-zoom (PTZ) camera as well as send and receive commands to the PTZ camera for altering its position and the like. There does not exist a solution today that combines power, video and control for a number of cameras on a single cable for the purpose of reducing cabling costs and simplifying installation and replacement.

Still another method uses wireless cameras. There are two fundamental problems that arise from this approach. First, video quality is often diminished because the available bandwidth is not great enough to support the full range of video data. Secondly, other wireless devices that fall within the range of other transmitters and receivers must share the wireless data channel. Therefore, data flow from continuously monitored sensors such as video cameras and microphones is interrupted. Data interruption is disturbing from a human factors perspective and unacceptable from a security perspective. As can be extrapolated by one familiar in the art, other transducers encounter similar shortcomings.

Audio distribution within a retail store, for example, typically is presented in two fixed formats. The first is the public address system in which general announcements and music are broadcast uniformly throughout a store. Secondly, local audio advertisements are played from a single source, either continuously or as a result of a motion sensor trigger. These local advertisements are typically unchanging over an extended period of time. Cost-effective distribution of multiple channels of audio over a broad area such as a retail store does not exist today. Therefore, the capability to dynamically support context relevent messages within a local proximity is not commercially available.

Recently, progress has been made in directing audio in an analogous manner that a beam of light might be directed to illuminate the listener. These systems require expensive, specially constructed loudspeakers, special signal processing, and a location of the listener's position to deliver the aural output, making such systems cost-prohibitive for general commercial and retail use.

Today, there does not exist a method for easily adding, swapping, or removing sensors and transducers within a system containing a number of these elements. For example, if it is desired to add a video camera, a speaker, or a microphone to a system, additional wiring and mounting must also be added. Accordingly, systems are invariably left alone and extending coverage of the system is not considered. If a sensor or transducer within a system fails, then a trained service technician is often required to carry out the replacement. In the manner that light bulbs are replaceable by a novice, there does not exist today a like-minded system for sensors and transducers.

For converting signals generated by analog sensors to a digital format that is suitable to computers and other digital processors, an ADC (analog to digital signal converter) or a decoder is required. Sensors that generate a formatted signal, such as the television signal that is produced by motion video cameras, require a specialized ADC known as a video decoder. A video decoder synchronizes to the intrinsic timing information within a video signal to decode and convert it. When a number of cameras are used as in a video surveillance system, each camera generally is asynchronous with respect to the other cameras. Therefore, each camera that is to be digitally converted requires a dedicated video decoder that is synchronized to its signal.

One method of reducing the cost of the decoders is to share one decoder with a plurality of cameras, multiplexing one camera at a time into the decoder. For many non-critical surveillance applications, this approach is acceptable, however, it suffers from the shortfall of resynchronizing each time a different camera signal is presented to the decoder. The result is that video information is lost while the video decoder begins its resynchronizing process.

Another method synchronizes all of the cameras so that in switching between cameras, synchronization is maintained and no video information is lost. This approach, however, requires distributing a common synchronization signal to all the cameras increasing wiring and equipment costs significantly. There does not exist a method today for synchronizing all of the cameras within a system to a common synchronization signal without significant increase in wiring cost.

Because individual video cameras as well as other sensors within multi-sensory systems are commonly composed of autonomous sensor elements, there does not exist today a simplified method of composing such systems without extensive set-up so that the data delivered from each sensor contains a unique identifier therein so as to discriminate the source of the sensor data elsewhere in the system from other sensor data. Nor does there exist a method today by which relative physical proximity between sensors or transducers are determined until after a system is installed and a separate system component is configured to relate each of the sensors or transducers to bear a relationship to the others or to it's physical location within the installation site.

### SUMMARY OF INVENTION

A node apparatus and methods supporting either a sensor or transducer nodes on a common signal conductor with a plurality of nodes is provided.

In a first aspect of the invention, a node containing a sensor, which is capable of sampling a physically measurable state of its environment and capable of sharing a common signal conductor with other sensor nodes is provided. A physical measurement is defined here to include any measurable quantity of the physical world for which a sensor is available for converting said measurement into and electrical signal. A common signal conductor is defined here as one or more electrical conductors bound together as a single elongated element so as to conduct one or more electrical signals from any defined point along said common signal conductor throughout its length. An electrical conductor is physically referring to a single wire or other conductive element. The connected node receives an address signal from the common signal conductor to which it is uniquely identified from other connected nodes, drives its electrical signal onto the common signal conductor. With this node type, this aspect of the invention provides significant savings in the cost of wiring and installation of a multi-node system.

A second aspect of the invention provides for the node being a transducer, which instead receives an analog electrical signal and converts said signal to a human perceptible output upon receiving its address signal. Transducers include loudspeakers, television displays, lights, and the like. For transducers, this advantageous configuration provides reduction in wiring and installation costs as well as a new apparatus for deploying a large number of discrete audio channels, video channels and the like that have the capability of receiving dynamically selected and delivered signals.

A third aspect of the invention provides for nodes that are field replaceable. Each field replaceable node contains an electrical connector that mechanically mates to a connector on the common signal conductor such that it may be easily removed and replaced. To share the common signal conductor and to readily support field replacement, the invention also provided for dynamic unique address assignment to each node for uniquely selecting each node. Accordingly, the invention provides significant labor and cost savings for field replacement, upgrades, and initial installation of a number of sensors or transducers.

In a fourth aspect of the invention, when the sensor nodes are video cameras, the present invention supports pan-tilt-zoom (PTZ) video cameras. Pan-tilt-zoom cameras require additional data to control its movements. This data is embodied in a movement signal that is carried on the common signal conductor. Therefore, additional cost of wiring and installation is spared.

In a fifth aspect of the invention wherein the nodes are video cameras, the analog signal provided by the actively driving camera node is a video signal. This invention provides for displaying the video signal onto a video monitor. This advantageous configuration provides expanded benefit for public view monitors (PVM's). PVM's are video surveillance systems that contain a video camera directly connected to a video monitor that is publicly viewable. These systems are typically used as deterrents and are rarely connected back to a central monitoring station. With the present invention, a plurality of cameras is inexpensively connected to a video monitor, expanding the coverage of a conventional PVM system.

A sixth aspect of the invention provides for a plurality of sensor nodes connected to a single ADC through a common signal conductor enabling any of the node's analog signal to be digitally converted by the decoder. When a node is actively driving it's analog signal onto the common signal conductor, then that node's analog signal is converted. The ADC enables interfacing to a microprocessor based system or other digital system. Significant cost savings and reduction in system complexity is achieved through the use of a single decoder connected to multiple selectable sensor nodes.

In a seventh aspect of the invention wherein the sensor nodes are video cameras, the analog signal is a video signal and the ADC is a video decoder, the invention provides for a common synchronization signal on the common signal conductor, the synchronization signal is used by each of the video camera nodes such that all of the video cameras are concurrently synchronous whereby a single video decoder may continuously decode the video signal without loss of synchronization and even though nodes are switching their video signal on and off the common signal conductor. In addition to significant cost savings and reduction in system complexity, the video shown on video displays does not roll or jump when cameras are switched.

An eighth aspect of the invention provides for insertion of a sensor node's unique address signal onto node's analog signal so that the origin of the signal, when converted using an ADC (analog-to-digital signal converter), is identified by the node's unique address contained therein.

A ninth aspect of the invention provides for a common signal conductor supporting power, control, and sensor or transducer analog signal for all nodes connected to said common signal conductor. Power is delivered to all nodes; control is used to select the node to drive or receive the analog signal; and the analog signal is conducted either from or to the node. All wiring elements for nodes are contained within the common signal conductor, reducing cabling and installation costs dramatically.

A tenth aspect of the invention provides for physical positioning between each of a set of nodes sharing a common signal conductor. Together with unique node addresses related to the positions on the common set of conductors, by construction of said common signal conductor, node positions are known. This advantage provides positioning context of sensors and transducers without additional set-up or configuration complexity as is required by systems today. Position context together with the data provided from or to a node becomes more useful when taken as a whole.

Additional objectives, advantages, and applications of the present invention will be made apparent by the following detailed description of embodiments of the invention.

### BRIEF DESCRIPTION OF DRAWINGS

FIG. 1 is a block diagram of a sensor node for use on a common signal conductor.

FIG. 2 is a block diagram of a plurality of sensor nodes sharing a common signal conductor.

FIG. 3 is a block diagram of a sensor node that supports dynamically assignment of an address that is unique from amongst a plurality of sensor nodes sharing a common signal conductor.

FIG. 4 is a flow chart illustrating a method of dynamically assigning unique addresses to nodes as illustrated in FIG. 3.

FIGS. 5a and 5b are diagrams of a field replaceable node and associated common signal conductor.

FIG. 6 is block diagram of a transducer node for use on a common signal conductor.

FIG. 7 is a block diagram of a plurality of motion video camera nodes together with a video monitor, on a common signal conductor.

FIG. 8 is a block diagram of a plurality of video camera nodes sharing a common signal conductor wherein one of the nodes is electromechanically moveable by a positioning signal so as to modify its field of view.

FIG. 9 is a block diagram of a plurality of frame-synchronizable video camera nodes sharing a common signal conductor that supports a synchronization signal, power, address signal, and enabled analog output.

FIG. 10 is a block diagram of a system of frame-synchronizable video camera nodes on a common signal conductor, which is connected to a video decoder for interfacing to a microprocessor-based system.

FIG. 11 is a block diagram of a system of sensor nodes on a common signal conductor, which is connected to an analog-to-digital signal converter for interfacing to a computer.

FIG. 12 is a block diagram of a sensor node for use on a common signal conductor wherein the node's output driver also drives a signal bearing its unique address onto a common signal conductor.

FIG. 13 is a block diagram of a system comprising a common signal conductor with nodes connected at known physical placements along the common signal conductor.

### DETAILED DESCRIPTION

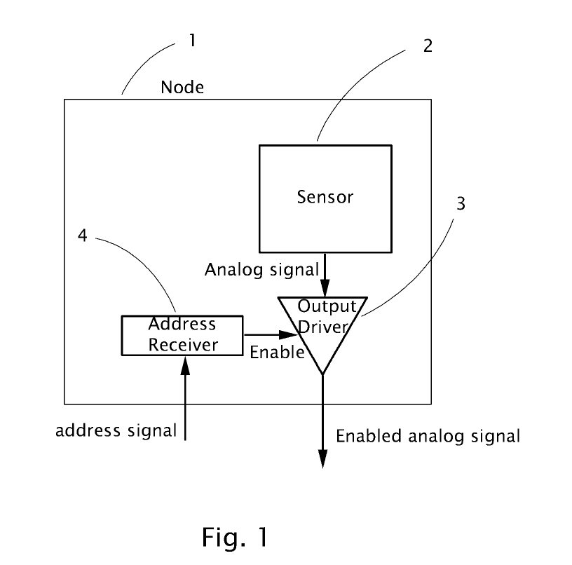

Referring now to FIG. 1, the present invention provides for a sensor node 1 which is capable of being electrically connected to a set of electrical conductors with other like sensor nodes as will be explained herein below. Within each sensor node 1 is contained a sensor 2 capable of measuring and converting a physical state into an analog electrical signal. Examples of measurable physical states include simple binary states such as a window or door being open or closed. More complex states include images and motion video, sound and light intensities for a variety of spectral responses, temperature and wind velocity, smoke and gas detection, and the like.

The sensor 2 produces an analog signal in response to the measurement, which is electrically input to an output driver 3. When its enable input is asserted, the output driver 3 passes the analog signal to it's output as an enabled analog signal. It is otherwise in a high impedance state on its output so as not to interfere with other like output drivers 3 contained within other like nodes electrically connected to its output by a shared electrical conductor.

The sensor node 1 has associated with it an address, which is unique among a plurality of such sensor nodes sharing an electrical conductor and likewise uniquely addressable. This unique address is contained within its address receiver 4. The input to the address receiver is likewise electrically connected to a shared electrical conductor from which it receives an address signal. If this address signal bears the unique address contained within, the address receiver 4 asserts an enable signal to the output driver 3, thereby driving the sensor's 2 analog signal through the output driver 3 so that it may be driven to a shared electrical conductor. Therefore the node 1, when addressed conducts its sensor's 2 analog signal on an electrical conductor shared with other like nodes 1 each with a different address such that at most only one node 1 is driving its enabled analog signal at one time. Upon receiving another address that is different than its unique address, the address receiver 4 de-asserts its enable signal thus disabling drive from the output driver 3 returning it to a high-impedance state. In practice, the address receiver 4 may be a latched comparator wherein the unique address contained therein is represented as one term in the comparator and the incoming digital address signal provides the other term.

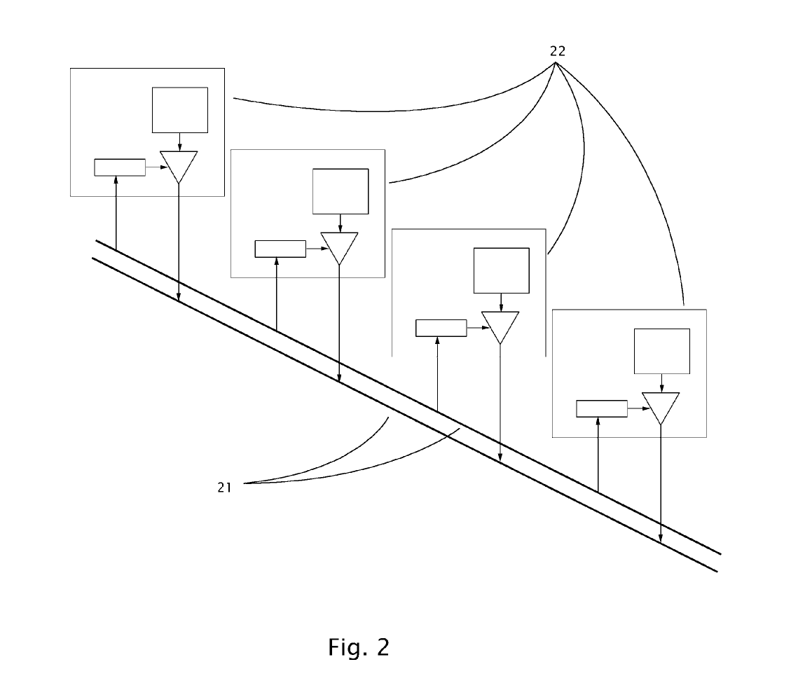

Referring now to FIG. 2, a plurality of sensor nodes 22 are shown electrically connected to and sharing a set of electrical conductors herein referred to as a common signal conductor 21. As described above, an analog signal and address signal are conducted onto the common signal conductor 21 such that all nodes 22 receive the same address signal and upon being uniquely addressed, one of the nodes 22 is enabled and hence drives its analog signal onto the common signal conductor 21. As shown in this figure, the common signal conductor 21 illustrates the use of two separate electrical conductors. As is apparent to one skilled in the art, there are known methods to conduct a number of signals on a smaller number of electrical conductors.

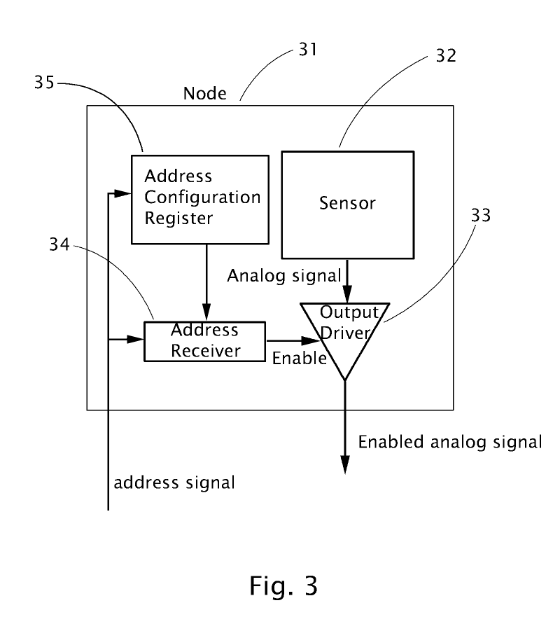

FIG. 3 is a block diagram of a sensor node 31 capable of dynamically receiving an address assignment that is unique from amongst a plurality of addressable sensor nodes sharing a common signal conductor. It is distinguished from the sensor node 1 of FIG. 1 by this feature. The foregoing description of dynamic address allocation is equally applicable to transducer nodes. To provide for this additional feature, an address signal received from a common signal conductor is electrically connected to the address receiver 34 as well as an address configuration register 35. The address receiver 34 does not assert an enable signal to the node's output driver 33 until the node 31 as been assigned an address. This assignment is captured into the address configuration register 35. Upon assignment, operation proceeds as previously described for FIG. 1. When the node's 31 unique address is received from the address signal, its sensor's 32 analog signal is driven through the output driver 33 as an enabled analog signal shown in FIG. 3. Upon receipt of an address other than the node's 31 unique address as captured by the address configuration register 35, the output driver 33 is disabled. As detailed for FIG. 1, the address receiver 34, which may be embodies as a latched comparator, is presented with the node's 31 unique address from the address configuration register 35.

There are several methods by which each address configuration register 35 amongst a plurality of like nodes may be initialized. One method uses a daisy chaining approach such that each node 31 along a common signal conductor receives an initialization command in turn before passing it onto the next node in line. Another method is to successively power up the nodes such that the most recently powered node without an assigned address, assumes the next address conducted on the address signal. There are other methods as is familiar to one who is skilled in the art.

There are several advantages of dynamic address allocation. All relate to a change in the number of properly functioning nodes sharing a common signal conductor. In general, dynamic address assignment is carried out once during a system initialization. If a node 31 were connected to a common signal conductor after this initial assignment, this node 31 would also dynamically receive a unique address assignment. Of significant advantage is that each node 31 may in practice be manufactured identically to others so that all nodes 31 are functionally equivalent until dynamic address allocation is carried out. This advantage simplifies field replacement as well since nodes 31 are standardized.

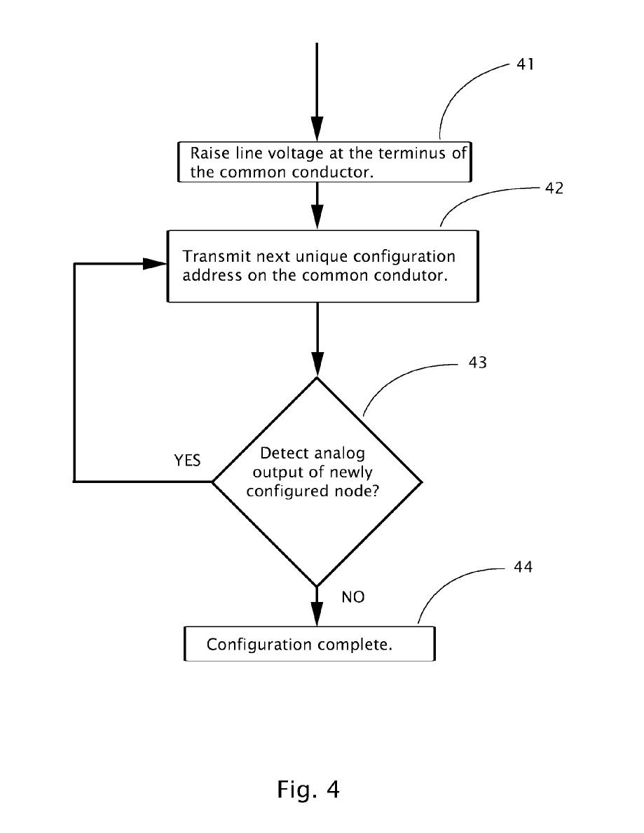

FIG. 4 is a flow chart for a method of dynamically assigning unique addresses to nodes as illustrated in FIG. 3 sharing a common signal conductor. The method is applied at the terminus of the common signal conductor and as detailed below, is acted upon by each node along the common signal conductor. This method of dynamic assignment successively powers up each node 31 in turn such that only one address configuration register 35 is initialized at a time. This method is the preferred embodiment when the common signal conductor is of significant enough length that the number electrical conductors are a significant cost factor.

In step 41, the line voltage to power the nodes is raised at the terminus of the common signal conductor. Capacitance in the line and at the nodes results in a gradual rise of the voltage as each node in turn powers up, successively moving further away from the terminus.

In step 42, a unique address is transmitted onto the common signal conductor. The first node to reach operating voltage, takes the assignment of that address. The node then enables its analog output onto the common signal conductor. If an analog output is detected step 43, then another unique address is transmitted onto the common signal conductor step 42 and the last node to receive assignment, now receives an address other than it's own and ceases to drive its enabled analog output onto the common signal conductor. If no analog output is detected step 43 after transmission, then configuration is complete step 44.

All nodes along the common signal conductor have unique address assignments and may therefore be addressed separately. To apply this method for transducer nodes, a different handshake method is be used since a transducer node receives rather than drives the analog output signal. Many variations for handshaking are well known in the art. In one application of this method, the set of unique addresses increase cardinally from one to the next. In this manner, each node has a numerically greater address when moving from one end of the common signal conductor to the other. This arrangement is advantageous for addressing nodes by physical position on the common signal conductor.

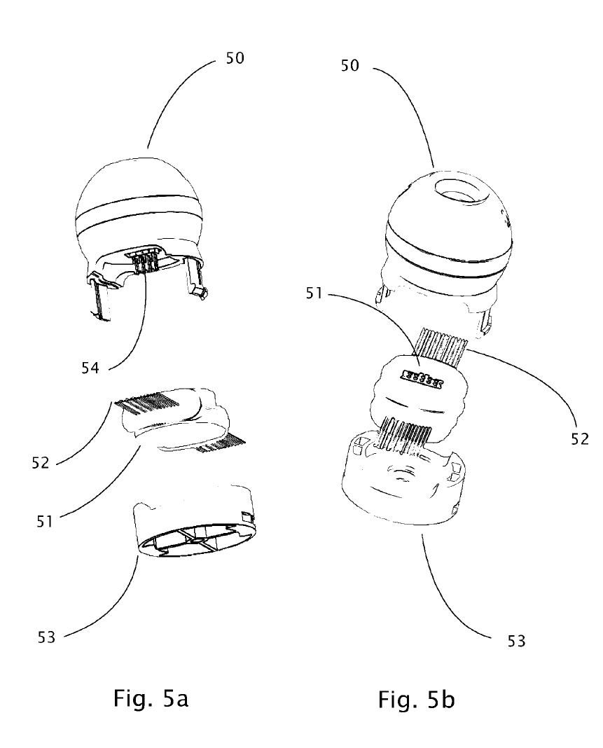

FIGS. 5a and 5b are diagrams of a field replaceable node and associated common signal conductor. Two separate views are provided here so as to clearly illustrate the node's 50 plug-in connector 54 and the common signal conductor's 52 mating connector 51. The node's 50 plug-in connector 54 electrically and mechanically interfaces to the common signal conductor's 52 mating connector 51. Field replacement is thus enabled. A mounting base 53 is shown here, as one embodiment, which provides one type of mounting option though it is not essential to enabling field replacement. The field replaceable node 50 taken together with dynamic address configuration as previously described, provide the advantages of simple field upgrade or replacement using standard nodes that are plugged into the same common signal conductor. Such field replacement is not restricted to sensor nodes but also applies to transducer nodes.

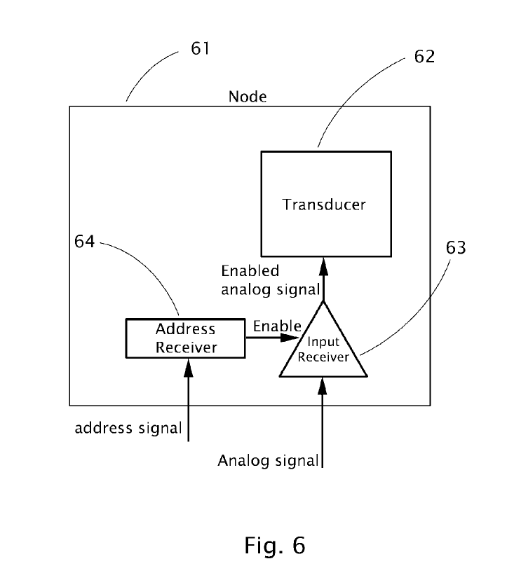

FIG. 6 is block diagram of a transducer node. The present invention provides for a transducer node 61, which is capable of being electrically connected to a common signal conductor with other like transducer nodes 61 as will be explained herein below. Within each transducer node 61 is contained a transducer 62 capable of converting an analog electrical signal into a human perceptible output. Transducers include loudspeakers, television displays, lights, and the like.

The transducer 62 produces a human perceptible output from an analog signal, which is received from an input receiver 63. When its enable is asserted, the input receiver 63 passes the analog signal to it's output as an enabled analog signal. It is otherwise in an inactive state so that its output results in no perceptible output from the transducer 62.

The transducer node 61 has associated with it an address, which is unique among a plurality of like transducer nodes 61 sharing a common signal conductor. This unique address is contained within the address receiver 64. The input to the address receiver is likewise electrically connected to the common signal conductor from which it receives an address signal. If this address signal bears the unique address contained within, the address receiver 64 asserts an enable signal to the input receiver 63, thereby driving the analog signal through the input receiver 63 so that the transducer 62 may convert it. Therefore the node 61, when addressed conducts to the transducer 62 the analog signal on an electrical conductors shared with other like nodes 61 each with a unique address such that at most only one node 61 is addressed at one time for each received address. Unlike sensor nodes however, multiple transducer nodes may be active on a shared set of conductors at a given time. Upon receiving its address again, the address receiver 64 de-asserts its enable signal thus disabling drive from the input receiver 63 returning it to a high-impedance state. Therefore, successively addressing a node toggles its enabled state.

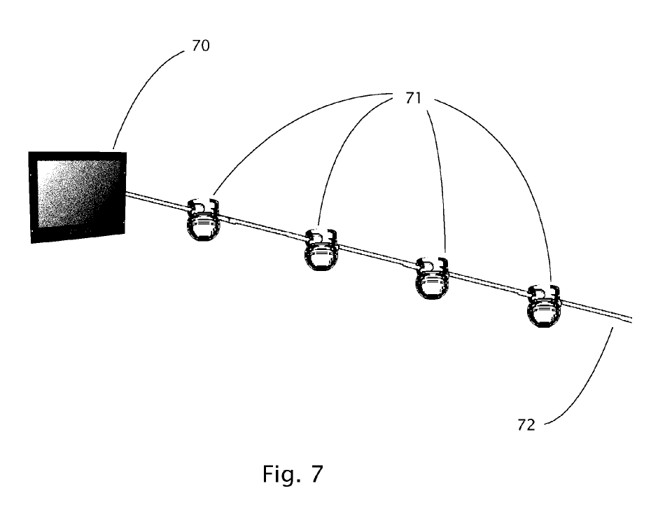

FIG. 7 is a block diagram of a plurality of motion video camera nodes 71 and a display device 70 such as a video monitor sharing a common signal conductor 72. This aspect of the invention illustrates the utility of combining a plurality of sensors each capable of producing an analog signal on a single common signal conductor and one or more transducers capable of converting said analog signal. Referring to FIG. 7, a plurality of motion video camera nodes 71 are electrically connected to a common signal conductor 72. Each of the motion video camera nodes 71 is uniquely selectable such that when selected, only one of the motion video cameras 71 drives an analog video signal onto the common signal conductor 72 at a time. The display device 70 receives an analog video signal from the common signal conductor 72 and displays video from the selected motion video camera node. The present invention therefore provides for both sensors and transducer nodes supporting compatible signals, all connected to the same common signal conductor. As is apparent to one skilled in the art, the invention also supports multiple microphones and speakers sharing a common signal conductor. Any set of signal and sensory compatible nodes may share a common signal conductor in a like manner.

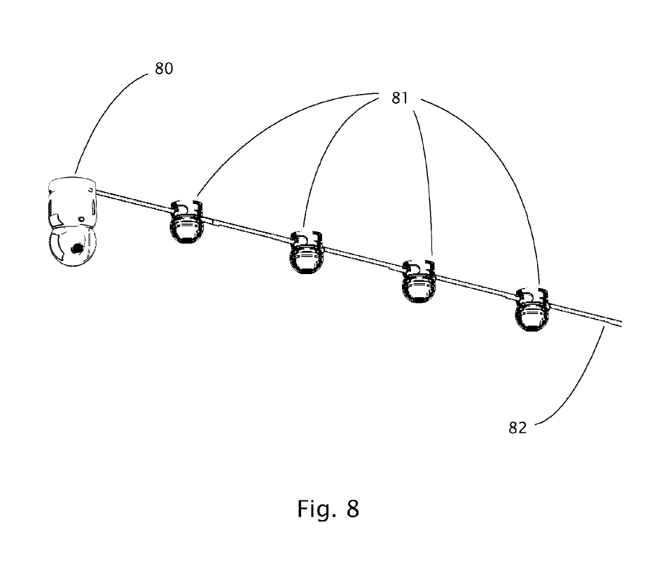

FIG. 8 is a block diagram of a plurality of addressable video camera nodes 81 sharing a common signal conductor 82 wherein one of the nodes is an electromechanically moveable video camera 80 by a movement signal so as to modify its field of view. Each of the video camera nodes 81 and the electromechanically moveable video camera 80 have associated therewith a unique address wherein each is uniquely selectable by receiving an address signal from the common signal conductor 80 bearing its unique address. When selected, one of the nodes 81 or moveable camera 80 drives its analog video signal onto the common signal conductor 80. Additionally, when the moveable camera 80 is selected, it also responds to a movement signal conveyed to it by the common signal conductor 80. The moveable camera 80 responds to the movement signal so as to modify its field of view. The invention therefore provides further advantage of sharing a common signal conductor for selecting not only one of many video cameras but also modify its position if the selected camera is moveable.

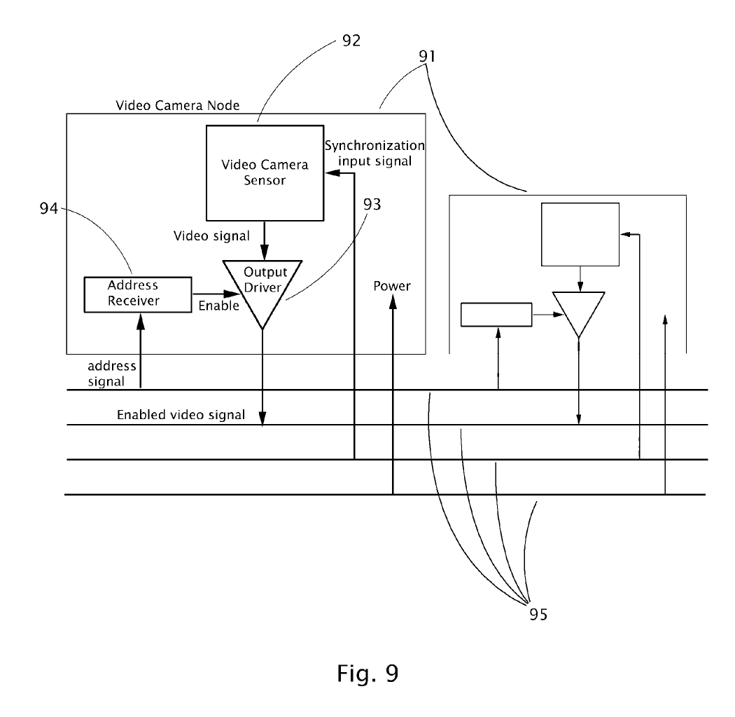

FIG. 9 is a block diagram of a plurality of uniquely addressable, frame-synchronizable cameras 91 sharing a common signal conductor 95 supporting common synchronization input signal, power, address signal, and enabled video signal. The video camera nodes 91 are video frame synchronizable to a synchronization input signal, which is received by the video camera sensor 92. All video camera nodes 91 are therefore frame-synchronized to one another thus enabling selection from one video camera node to the next without change of synchronization in the enabled video signal also on the common signal conductor 95. This benefit allows external devices to receive the enabled video signal without having to resynchronize as different video camera nodes 91 are selected. Resynchronization manifests several detrimental artifacts. If the external device is a video display, the picture will roll or cut when a different node is selected. If the external device is a video decoder for use with computers and other microprocessor based systems, frame data will be lost during the resynchronization process.

Additionally, all video camera nodes 91 receive their power source from the common signal conductor 95. Each of the nodes 91 is addressed by an address signal, which bears its unique address. This signal from the common signal conductor 95 is received by the address receiver 94, which then enables the output driver 93 so as to drive the video camera sensor's 92 video signal onto the common signal conductor 95 as the enabled video signal.

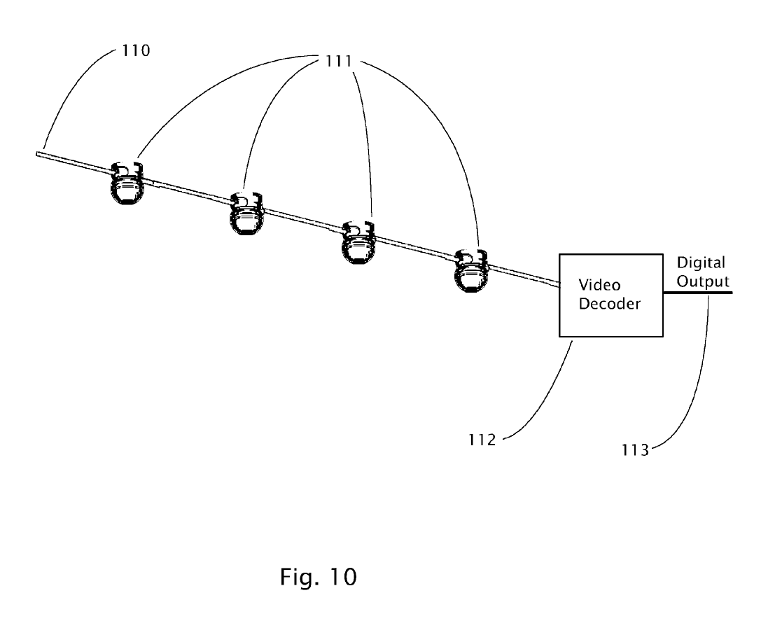

FIG. 10 illustrates such a system of uniquely addressable, frame-synchronizable video camera nodes 111 sharing a common signal conductor 110, which is connected to a video decoder 112 for interfacing to a microprocessor-based system. The video decoder 112 receives the enabled video signal and converts it to digital data at its digital output 113. Selecting from one camera to the next does not interrupt the stream of digital data because video frame synchronization is maintained. Such a system advantageously combines not only the cabling for all the video cameras but enables the use of only one video decoder since all video camera nodes 111 are frame synchronized to one another.

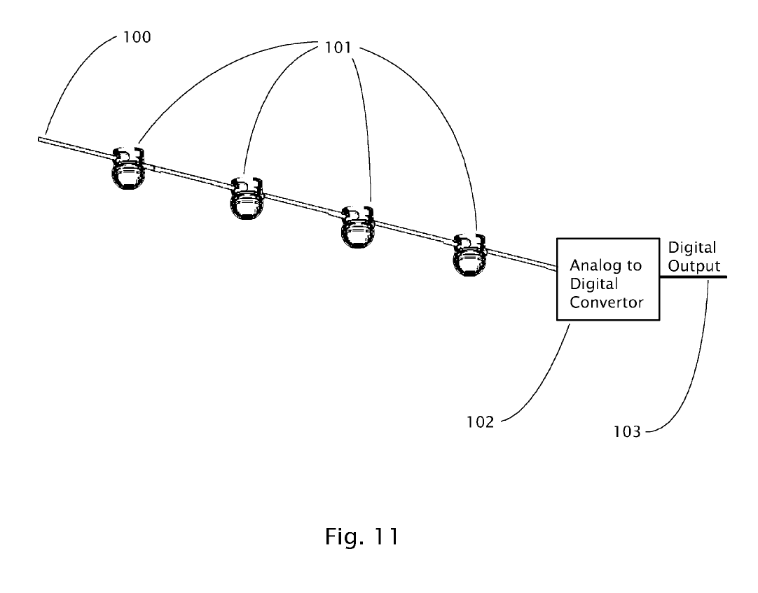

FIG. 11 is a block diagram of a system of addressable sensor nodes 101 sharing a common signal conductor 100, which is connected to an analog-to-digital signal converter 102 for interfacing to a computer or other microprocessor based system at its digital output 103. This is the general case to the video camera nodes interfaced to a video decoder as described above. Most types of sensor nodes can be sampled with an analog-to-digital signal converter 102 as opposed to the special purpose video decoder. At the analog-to-digital converter 102, an analog signal is received on the common signal conductor 100 from one of the currently addressed sensor nodes 101 and is converted to a digital signal output for use by a microprocessor system.

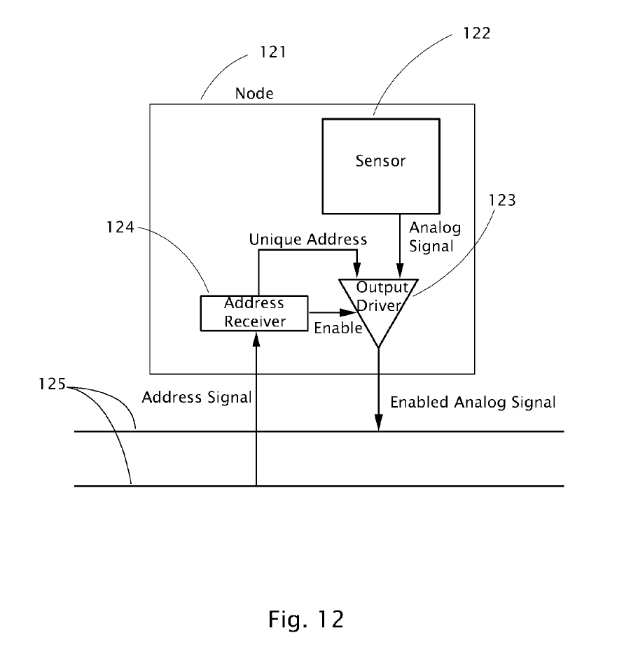

FIG. 12 is a block diagram of a sensor node 121 having associated to it an address. Within the sensor node 121 is an output driver 123 wherein it drives not only the analog signal from the sensor 122 but also drives a signal bearing the sensor node's 121 address as output from the address receiver 124. When the output driver 123 is enabled, a signal bearing the address of the node 121 with the sensor's 122 analog signal is driven onto a common signal conductor 125. Also, as previously described above, when a plurality of like sensor nodes 121 share the common signal conductor 125, each has an address associated to it that is unique from all others connected to the common signal conductor 125. When the address receiver 124 receives an address signal bearing the sensor node's associated address at its input, it enables the output driver 123. When it receives an address signal bearing another address, the address receiver 124 disables the output driver 123.

The present invention therefore advantageously provides for having the sensor node's unique address included with its enabled analog signal, enabling the source of this signal to be distinguished from the enabled analog signal sourced by other sensor nodes on the common signal conductor 125. If an analog-to-digital signal converter or a video decoder receives the enabled analog signal for instance (as previously described), then a microprocessor system would be able to determine the source of the data. As is well known in the art, there are many ways to include both signals on the output for later separation.

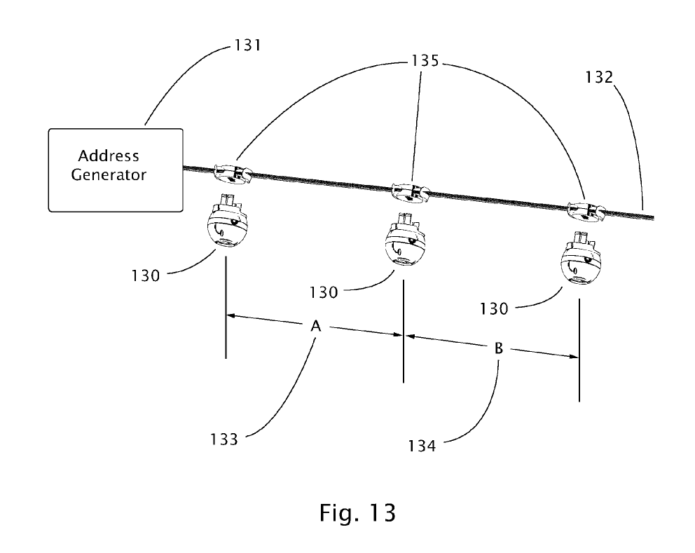

FIG. 13 is a block diagram of a system comprising uniquely addressable nodes 130 for electrically and mechanically connecting to known physical positions of node connectors 135 along a common signal conductor 132. By construction, the physical positions between connected nodes are shown as distance A 133 and distance B 134. An address generator 131 is electrically connected to the common signal conductor so as to deliver a signal bearing the addresses of the nodes 130 for selection. The address generator 131 may be a simple counter that selects one node after another in a round robin fashion or it may select nodes based on any other type of condition or pattern. Taken together with the location of the nodes 130, the address generator 131 may also generate addresses based on the need to deliver or collect data at a specific physical location.

As described previously for FIG. 12, it is advantageous to know the source node of the data from the analog signal. It is also advantageous to know the physical location or position of nodes to provide context for data collected by sensor nodes and data sent to transducer nodes. This advantage provides positioning context of sensors and transducers without additional set-up or configuration complexity as is required by systems today. In the present invention, position context together with data are now provided as a whole.

What is claimed is:

1. A sensor node having associated therewith an address comprising:
a sensor for converting a physical measurement into an analog electrical signal;
an output driver responsive to an enabling signal for driving said analog electrical signal onto a common signal conductor;
an address receiver for receiving an address signal bearing said address associated with said node and enabling said output driver upon receipt of said address signal and disabling upon receipt of said address signal bearing another address.

2. A plurality of sensor nodes in claim 1 wherein the sensor nodes receive said address signal and are electrically connected to said common signal conductor.

3. A sensor node in claim 1 wherein the sensor node is a video camera.

4. A sensor node in claim 3 wherein the video camera is synchronized by a synchronization signal on a common signal conductor.

5. A sensor node in claim 1 wherein the sensor node is a microphone.

6. A sensor node having a dynamically assignable address comprising:
a sensor for converting a physical measurement into an analog electrical signal;
an output driver responsive to an enabling signal for driving said analog electrical signal onto a common signal conductor;
an address configuration register for dynamically receiving and storing an assigned address, and
an address receiver for receiving an address signal bearing said address assigned to said node and enabling said output driver upon receipt of address signal bearing said assigned address and disabling upon receipt of said address signal bearing another address.

7. The sensor node of claim 6 also comprising a plug-in connector for electrically and mechanically connecting said node to a said common signal conductor having a mating connector
whereby sensor node is field replaceable.

8. The sensor node in claim 6 wherein the sensor node is a video camera.

9. A transducer node having associated therewith an address comprising:
a transducer for converting an analog electrical signal into a human perceptible output;
an input receiver responsive to an enabling signal for receiving said analog electrical signal from a common signal conductor;
an address receiver for receiving an address signal bearing said address associated with said node and enabling said input driver upon receipt of said address signal when said input driver is disabled and disabling upon receipt of said address signal bearing said address when said input driver is enabled.

10. A transducer node having a dynamically assignable address comprising:
a transducer for converting an analog electrical signal into a human perceptible output;
an input driver responsive to an enabling signal for receiving said analog electrical signal from a common signal conductor;
an address configuration register for dynamically receiving and storing an assigned address, and
an address receiver for receiving an address signal bearing said address associated with said node and enabling said input driver upon receipt of said address signal and then disabling upon receipt of said address signal bearing said address.

11. The transducer node of claim 10 also comprising a plug-in connector for electrically and mechanically connecting said node to said common signal conductor having a mating connector,
whereby transducer node is field replaceable.

12. A plurality of selectable motion video camera nodes sharing a common signal conductor, comprising:
at least two video camera nodes, each producing an analog video signal, each uniquely selectable such that when selected, one of said video camera nodes drives said analog video signal onto a common signal conductor,
a common signal conductor electrically connected to said camera nodes for conducting said analog video signal from a selected camera such that the video signal is displayable on a display device.

13. A video camera system comprising:
a plurality of addressable video camera nodes each associated therewith a unique address,
wherein each of said nodes drives an analog video signal when addressed by an address signal bearing its unique address, and
wherein at least one of said nodes is electromechanically moveable by a movement signal so as to modify the field of view of the video camera, and
a common signal conductor comprising a plurality of electrical conductors connected to said nodes for;
conducting said analog signal of an addressed node,
conducting an address signal to all of said nodes, and
conducting a movement signal to all of said nodes,
whereby video camera nodes are individually selectable for output and movements, and
whereby all video camera nodes are electrically connected to a common set of conductors.

14. The video camera system of claim 13 wherein said video camera nodes are video frame-synchronized to a synchronization input signal, and said common signal conductor also comprises an electrical conductor for conducting a synchronization input signal to said video camera nodes
whereby all of said video camera nodes are concurrently frame synchronizable.

15. The video camera system of claim 13 wherein said common signal conductor also comprises an electrical conductor for conducting power to said video camera nodes.

16. A system of sensors for interfacing to a microprocessor system comprising:
a plurality of addressable sensor nodes each associated therewith a unique address,
wherein each of said nodes drives an analog signal when addressed by an address signal bearing its unique address, and
a common signal conductor comprising a plurality of electrical conductors connected to said nodes for;
conducting said analog signal of an addressed node,
conducting an address signal to all of said nodes, and
an analog to digital signal converter for converting said analog signal of an addressed node to a digital signal connected to said common signal conductor for conducting said analog signal of an addressed node,
whereby a microprocessor system may individually select each one of said sensor nodes by generating an address signal bearing said associated unique address, and
whereby a microprocessor system is capable of reading said digital signal.

17. The system of sensors in claim 16
wherein said sensor nodes are video camera sensor nodes, and
wherein said analog to digital signal converter is a video decoder.

18. The system of sensors in claim 17 wherein said video camera sensor nodes are video frame-synchronizable to a synchronization input signal, and said common signal conductor also comprises an electrical conductor for conducting a synchronization signal to said video camera nodes
whereby said video camera nodes are concurrently frame synchronizable.

19. Said sensor node of claim 1 wherein said output driver also drives a signal bearing said address onto said common signal conductor when said output driver is enabled.

20. A cable assembly for connecting a plurality of transducer nodes of a multiple transducer node system with a common signal conductor for conducting analog and digital signals comprising:
conductors for power, signal and address common to more than one transducer connected to said cable assembly;
a plurality of connectors, each for receiving one transducer node into cable and electrically and mechanically connecting to said conductors; and
address generation circuitry for generating and driving address data onto address conductor to enable at least one transducer node electrical connected to signal conductor.

21. A cable assembly for connecting a plurality of sensor nodes of a multiple transducer node system with a common signal conductor for conducting analog and digital signals comprising:
conductors for power, signal and address common to more than one transducer connected to said cable assembly;
a plurality of connectors, each for receiving one transducer node into said cable and electrically and mechanically connecting to said conductors and each having predetermined physical locations at sites on said conductors; and
address generation circuitry for generating and driving address data onto address conductor to enable at least one sensor node electrical connected to signal conductor.

22. A plurality of selectable sensor nodes sharing a common signal conductor, comprising:
at least two sensor nodes, each producing an analog signal, each uniquely selectable such that when selected, one of said sensor nodes drives said analog signal onto a common signal conductor,
a common signal conductor electrically connected to said sensor nodes for conducting said analog signal from a selected camera such that the signal is convertible by a signal and sensory compatible transducer node.

23. A method of dynamically assigning a unique address to a plurality of nodes electrically connected to a common signal conductor comprising power, address, and analog signal for all of said nodes, comprising:
raising line voltage at the terminus of said common signal conductor such that each node is successively powered up in turn as each unique address is assigned,
transmitting a unique address onto said common conductor for assignment to a next powered up node,
detecting an analog output from said next powered up node to verify a node was present and said unique address was assigned,
whereby a plurality of nodes connected to a common signal conductor are assigned unique addresses, and
whereby each of nodes with unique address assignments are individually selectable.

24. The method of claim 23 wherein said nodes are sensor nodes.

25. The method of claim 23 wherein said nodes are transducer nodes.

26. The method of claim 23 wherein unique addresses increase cardinally after each assignment.
